(19) United States
(12) Patent Application Publication
(10) Pub. No.: US 2016/0210109 A1
(43) Pub. Date: Jul. 21, 2016

(54) METHOD FOR CONTROLLING AUDIO PLAYING OF AN ELECTRONIC DEVICE, AND ASSOCIATED APPARATUS AND ASSOCIATED COMPUTER PROGRAM PRODUCT

(71) Applicant: MEDIATEK INC., Hsin-Chu (TW)

(72) Inventors: Hui-Wen Wang, Taipei City (TW); Tsung-Te Wang, Taipei City (TW); Yi-Kai Lee, New Taipei City (TW)

(21) Appl. No.: 14/599,549

(22) Filed: Jan. 19, 2015

(51) Int. Cl. G06F 3/16; G06F 3/0488; G06F 3/0484; G06F 3/041

(52) U.S. Cl. CPC G06F 3/165; G06F 3/0416; G06F 3/04883; G06F 3/0484

(57) ABSTRACT

A method for controlling audio playing of an electronic device, an associated apparatus and an associated computer program product are provided, where the method includes: controlling a touch panel of the electronic device to be active, to allow at least one touch gesture input to be received from the touch panel while an audio player application is running on the electronic device, wherein when the at least one touch gesture input is received from the touch panel, a screen of the electronic device is kept turned off; and determining whether a specific touch gesture input of the at least one touch gesture input matches a pre-defined gesture to generate a determining result, and controlling the audio player application to execute a pre-defined command corresponding to the pre-defined gesture based on the determining result.

### BACKGROUND

The present invention relates to an audio player application running on an electronic device, and more particularly, to a method for controlling audio playing of an electronic device, and an associated apparatus and an associated computer program product.

According to the related art, when a user is listening to an audio file such as music through an audio player application running on a conventional portable electronic device such as a conventional multifunctional mobile phone, the whole device screen such as the touch sensitive screen of the conventional multifunctional mobile phone is usually turned off as this activity does not require the user's visual attention. Based on the conventional design scheme of the conventional portable electronic device, there is no need to keep turning on the backlight to display the user interface (UI) of the audio player application, and while listening to the audio file, the user may do something else simultaneously since no visual attention regarding the audio file is needed. However, some problems may occur. For example, when the user simply wants to repeat a song, the user typically needs to press the power button to turn on the screen first and then bring up the UI, and find a corresponding button (e.g. a virtual button displayed on the screen) to press. In another example, when the user simply wants to skip a song and play the next one, the user typically needs to press the power button to turn on the screen first and then bring up the UI, and find a corresponding button (e.g. a virtual button displayed on the screen) to press. Please note that, in any of these examples, an action typically takes several steps to achieve.

Some conventional methods in the related art are proposed to try solving these problems. However, further problems such as some side effects may occur. For example, a first conventional method suggests using air gestures to control the playing of music, which is not intuitive and takes more space to perform the air gesture. In another example, a second conventional method suggests using touch gesture commands and requires that the application should run in the foreground, with the screen being turned on, for using the interface to take the gesture command. Although using the touch gesture is more intuitive, applying the second conventional method to the conventional portable electronic device causes the screen to be always turned on, which wastes power and reduces the battery life of the conventional portable electronic device.

In conclusion, the related art does not serve the user well. Thus, a novel method is required for improving the basic design architecture and enhancing the user experience with fewer side effects.

### SUMMARY

It is an objective of the claimed invention to provide a method for controlling audio playing of an electronic device, and an associated apparatus and an associated computer program product, in order to solve the above-mentioned problems.

It is another objective of the claimed invention to provide a method for controlling audio playing of an electronic device, and an associated apparatus and an associated computer program product, in order to enhance the user experience for end-users with fewer side effects.

According to at least one preferred embodiment, a method for controlling audio playing of an electronic device is provided, where the method comprises the steps of: controlling a touch panel of the electronic device to be active, to allow at least one touch gesture input to be received from the touch panel while an audio player application is running on the electronic device, wherein when the at least one touch gesture input is received from the touch panel, a screen of the electronic device is kept turned off; and determining whether a specific touch gesture input of the at least one touch gesture input matches a pre-defined gesture to generate a determining result, and controlling the audio player application to execute a pre-defined command corresponding to the pre-defined gesture based on the determining result.

According to at least one preferred embodiment, an apparatus for controlling audio playing of an electronic device is provided, where the apparatus comprises at least one portion of the electronic device. The apparatus comprises a processing circuit capable of controlling a touch panel of the electronic device to be active, to allow at least one touch gesture input to be received from the touch panel while an audio player application is running on the electronic device, wherein when the at least one touch gesture input is received from the touch panel, a screen of the electronic device is kept turned off. Additionally, the processing circuit is further capable of determining whether a specific touch gesture input of the at least one touch gesture input matches a pre-defined gesture to generate a determining result, and controlling the audio player application to execute a pre-defined command corresponding to the pre-defined gesture based on the determining result.

According to at least one preferred embodiment, a computer program product is provided, where the computer program product has program instructions for instructing a processor of an electronic device to perform a method comprising the steps of: controlling a touch panel of the electronic device to be active, to allow at least one touch gesture input to be received from the touch panel while an audio player application is running on the electronic device, wherein when the at least one touch gesture input is received from the touch panel, a screen of the electronic device is kept turned off; and determining whether a specific touch gesture input of the at least one touch gesture input matches a pre-defined gesture to generate a determining result, and controlling the audio player application to execute a pre-defined command corresponding to the pre-defined gesture based on the determining result.

It is an advantage of the present invention that the present invention method, the associated apparatus, and the associated computer program product can enhance the user experience for end-users with fewer side effects. More particularly, the present invention method, the associated apparatus, and the associated computer program product can provide the user with a quick and easy access to control the playing of audio file such as music using touch gestures. In contrast to the related art, the present invention method, the associated apparatus, and the associated computer program product can prevent many problems of the conventional methods (e.g. the non-intuitive problem, the power wasting problem, and the problem of reduced battery life).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for controlling audio playing of an electronic device according to a first embodiment of the present invention.

FIG. 2 illustrates a multifunctional mobile phone involved with the apparatus shown in FIG. 1 according to an embodiment of the present invention.

FIG. 3 illustrates a flowchart of a method for controlling audio playing of an electronic device according to an embodiment of the present invention.

FIG. 4 illustrates a control scheme involved with the method shown in FIG. 3 according to an embodiment of the present invention.

FIG. 5 illustrates a control scheme involved with the method shown in FIG. 3 according to another embodiment of the present invention.

FIG. 6 illustrates a control scheme involved with the method shown in FIG. 3 according to another embodiment of the present invention.

FIG. 7 illustrates a control scheme involved with the method shown in FIG. 3 according to another embodiment of the present invention.

FIG. 8 illustrates a control scheme involved with the method shown in FIG. 3 according to another embodiment of the present invention.

FIG. 9 illustrates a control scheme involved with the method shown in FIG. 3 according to another embodiment of the present invention.

FIG. 10 illustrates a control scheme involved with the method shown in FIG. 3 according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

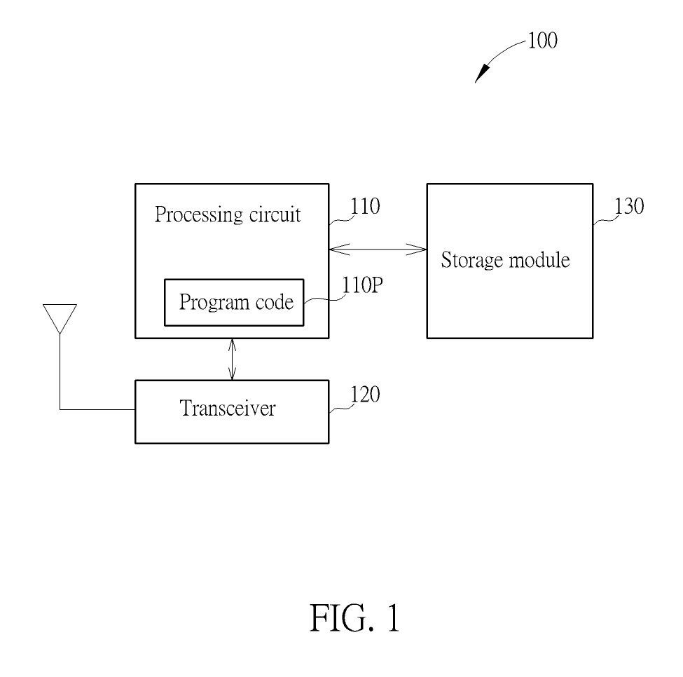

Please refer to FIG. 1, which illustrates a diagram of an apparatus 100 for controlling audio playing of an electronic device according to a first embodiment of the present invention, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device. In another example, the apparatus 100 can be the whole of the electronic device mentioned above. In another example, the apparatus 100 may comprise a system comprising the electronic device mentioned above (e.g. an audio/video system comprising the electronic device). Examples of the electronic device may include, but not limited to, a mobile phone (e.g. a multifunctional mobile phone), a personal digital assistant (PDA), a personal computer such as a laptop computer, a tablet and a wearable device.

As shown in FIG. 1, the apparatus 100 may comprise a processing circuit 110 arranged to control operations of the electronic device, and may further comprise a transceiver 120 arranged to transmit and/or receive signal for the electronic device, where the transceiver 120 may be coupled to the processing circuit 110, and one or more antennas of the electronic device may be coupled to the transceiver 120. For example, the processing circuit 110 may comprise at least one processor (e.g. one or more processors) and associated hardware resources, where the processor may execute some program codes 110P (e.g. program instructions). The processing circuit 110 may further comprise at least one microprocessor (e.g. one or more microprocessors). The transceiver 120 may comprise a transmitter and a receiver such as those for wireless network communications. The apparatus 100 may further comprise a storage module 130 (e.g. a hard disk drive (HDD), a non-volatile memory such as a Flash memory, a volatile memory such as a dynamic random access memory (DRAM), etc.) arranged to store information for the electronic device. The processing circuit 110 may be arranged to control the aforementioned operations of the electronic device according to the program codes 110P (e.g. program instructions) loaded (or retrieved) from the storage module 130. In another example, the program codes 110P may be stored in a storage module internal to the processing circuit 110. According to some embodiments, the apparatus 100 may not comprise all of the transceiver 120 and the storage module 130. In some of these embodiments, at least one of the transceiver 120 and the storage module 130 (e.g. the transceiver 120 and/or the storage module 130) may be positioned outside the apparatus 100. In some of these embodiments, at least one of the transceiver 120 and the storage module 130 (e.g. the transceiver 120 and/or the storage module 130) may be omitted.

The electronic device may comprise a touch sensitive display module (not shown in FIG. 1), where the touch sensitive display module may comprise a display module (e.g. a liquid crystal display (LCD) module, an organic light emitting diode (LED) display module, etc.) and a touch panel (e.g. a transparent touch panel on the display module), both of which can be implemented according to the related art. The display module can be referred to as a screen. The aforementioned at least one microprocessor can be utilized for performing some operations, such as detecting touch gesture input(s), in a situation where the screen (including the backlight therein, if any) is turned off and the touch panel is kept active. This is for illustrative purposes only, and is not meant to be a limitation of the present invention. In another example, the aforementioned at least one microprocessor can simply be utilized for detecting whether there is a touch input applied to the touch panel. In some other examples, these operations, such as that for detecting touch gesture input(s), can be performed without using the aforementioned at least one microprocessor.

According to this embodiment, the processing circuit 110 may control the touch panel of the electronic device to be active to take or to allow at least one touch gesture input to be received from the touch panel while an audio player application, such as a music player application, is running on the electronic device. In one embodiment, the audio player application is running on the electronic device may mean that the audio player application is ready to take command(s) such as play, pause, stop, forward, rewind, repeat, etc. For one example, the audio player application may be playing an audio file such as music and is ready to take other command(s) such as pause, forward, rewind, etc. For another example, the audio player application may be in a standby state and ready to take commands such as randomly play an audio file in the library.

In one embodiment, the processing circuit 110 may further determine whether a specific touch gesture input of the at least one touch gesture input matches a pre-defined gesture to generate a determining result and control the audio player application to execute a pre-defined command corresponding to the pre-defined gesture based on the determining result. For example, when it is determined that a touch gesture input matches a pre-defined gesture, the audio player application may take (or receive) this touch gesture input and execute the associated command in response to this touch gesture input. In one embodiment, the touch panel can be kept as turned on, so the user can use touch gesture inputs anytime without turning on the screen (such as the LCD module, including the backlight therein) and without looking at the screen or any user interface (UI). This is for illustrative purposes only, and is not meant to be a limitation of the present invention. According to some variations of this embodiment, the touch panel and the display module may not be integrated into the same module such as the touch sensitive display module mentioned above. That is, in a situation where the touch panel and the display module are positioned at different locations of the electronic device, the operations disclosed above can still be applied to the electronic device. For example, in this situation, the electronic device can be a laptop computer, wherein the touch panel (e.g. a touch pad) and the screen are located at different positions.

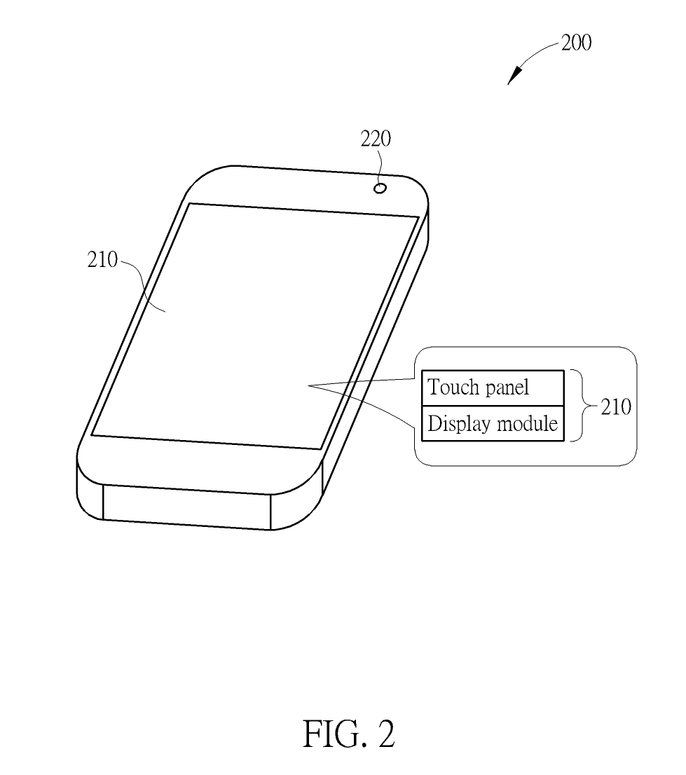

FIG. 2 illustrates a multifunctional mobile phone 200 involved with the apparatus 100 shown in FIG. 1 according to an embodiment of the present invention, where the multifunctional mobile phone 200 can be taken as an example of the electronic device mentioned above. As shown in FIG. 2, the multifunctional mobile phone 200 may comprise a touch sensitive display module 210 and a camera 220, where the touch sensitive display module 210 can be taken as an example of the touch sensitive display module mentioned above. This is for illustrative purposes only, and is not meant to be a limitation of the present invention.

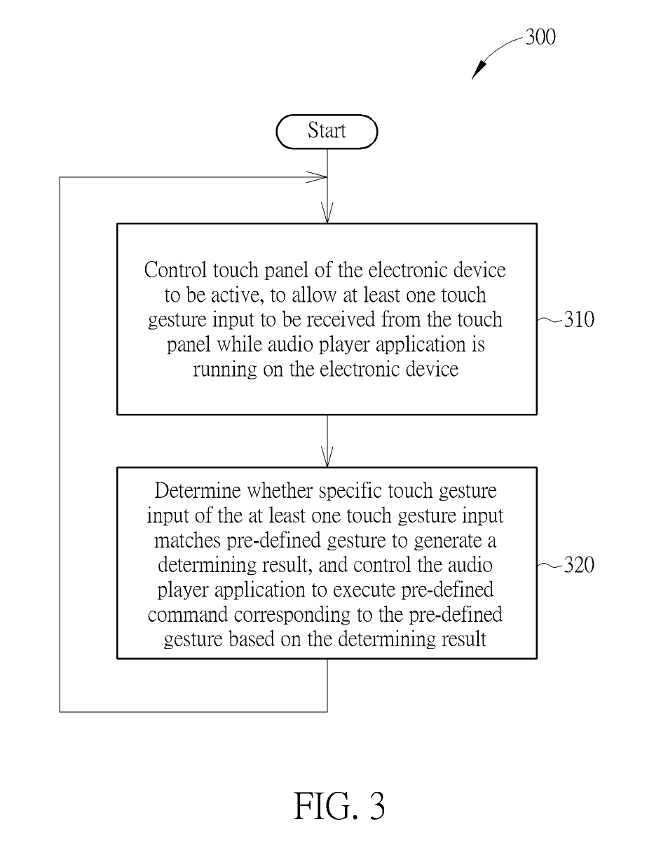

FIG. 3 illustrates a flowchart of a method 300 for controlling audio playing of an electronic device according to an embodiment of the present invention. The method 300 shown in FIG. 3 can be applied to the apparatus 100 shown in FIG. 1 (for example, the multifunctional mobile phone 200 of the embodiment shown in FIG. 2), and can be applied to the processing circuit 110 thereof (for example, the processing circuit 110 executing the program codes 110P of the embodiment shown in FIG. 1). For example, the program code 110P may be provided through a computer program product having program instructions (such as those mentioned above) for instructing a processor such as that mentioned above to perform the method 300 shown in FIG. 3, where the computer program product may be implemented as a non-transitory computer-readable medium (e.g. a floppy disk or a compact disc-read only memory (CD-ROM)) storing the program instructions or an equivalent version thereof, such as a software package for being installed. This is for illustrative purposes only, and is not meant to be a limitation of the present invention. The method can be described as follows.

In Step 310, the processing circuit 110 may control a touch panel of the electronic device to be active, to allow at least one touch gesture input (e.g. one or more touch gesture inputs) to be received from the touch panel while an audio player application such as that mentioned above is running on the electronic device, wherein when the aforementioned at least one touch gesture input is received from the touch panel, a screen of the electronic device may be kept turned off. For one example, during receiving the aforementioned at least one touch gesture input for the audio player application, the processing circuit 110 may prevent the screen of the electronic device from being turned on. For another example, during receiving the aforementioned at least one touch gesture input for the audio player application, the processing circuit 110 may prevent the screen of the electronic device from being turned on, to allow the at least one touch gesture input to be received from the touch panel, no matter whether the audio player application is running in the foreground or the background. This is for illustrative purposes only, and is not meant to be a limitation of the present invention. In another example, during receiving the at least one touch gesture input for the audio player application, the processing circuit 110 may block the aforementioned at least one touch gesture input from being obtained by any other application, to allow the aforementioned at least one touch gesture input to be received from the touch panel, no matter whether the audio player application is running in the foreground or the background.

In Step 320, the processing circuit 110 may determine whether a specific touch gesture input of the at least one touch gesture input matches a pre-defined gesture to generate a determining result, and may control the audio player application to execute a pre-defined command corresponding to the pre-defined gesture based on the determining result. For example, a shape of the pre-defined gesture may correspond to a symbol of a virtual button of a user interface (UI) of the audio player application. This is for illustrative purposes only, and is not meant to be a limitation of the present invention. In another example, the pre-defined gesture may correspond to one of sliding to the left direction on the touch panel and sliding to the right direction on the touch panel, and the pre-defined command may correspond to one of switching to the previous entity to be played by the audio player application and switching to the next entity to be played by the audio player application. In another example, the pre-defined gesture may correspond to double tap, and the pre-defined command may correspond to at least one of play and pause. Besides, in one example, during determining whether the specific touch gesture input of the at least one touch gesture input matches the pre-defined gesture to generate the determining result, the processing circuit 110 may prevent the screen of the electronic device from being turned on.

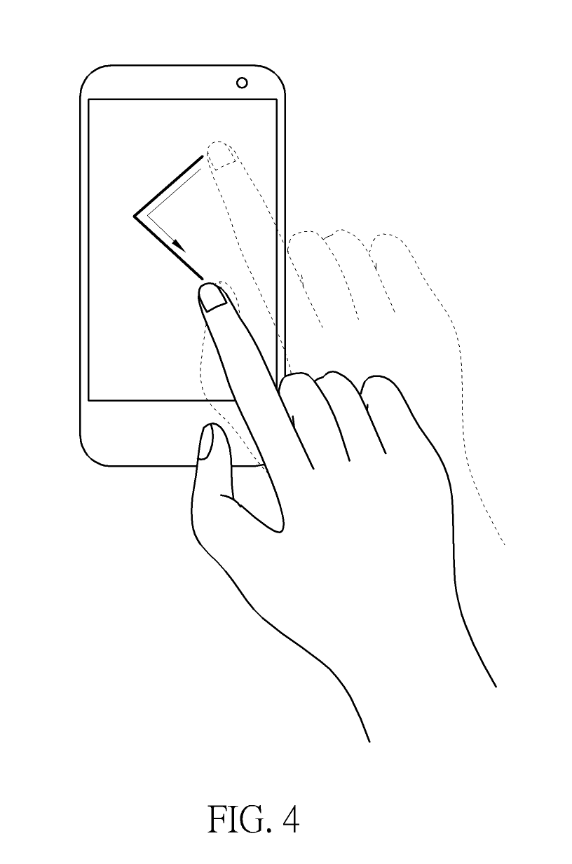

FIG. 4 illustrates a control scheme involved with the method 300 shown in FIG. 3 according to an embodiment of the present invention. For example, the shape of the pre-defined gesture may correspond to the symbol of the virtual button of the UI of the audio player application. In one embodiment, the shape of the pre-defined gesture may correspond to that of the notation “<”, which may comprise (e.g. is formed with) two lines that may be generated by sliding on the touch panel and drawing the notation “<” with one finger of the user, and the pre-defined command may be (or may represent) switching to the previous entity to be played by the audio player application, e.g. the Previous or Rewind command.

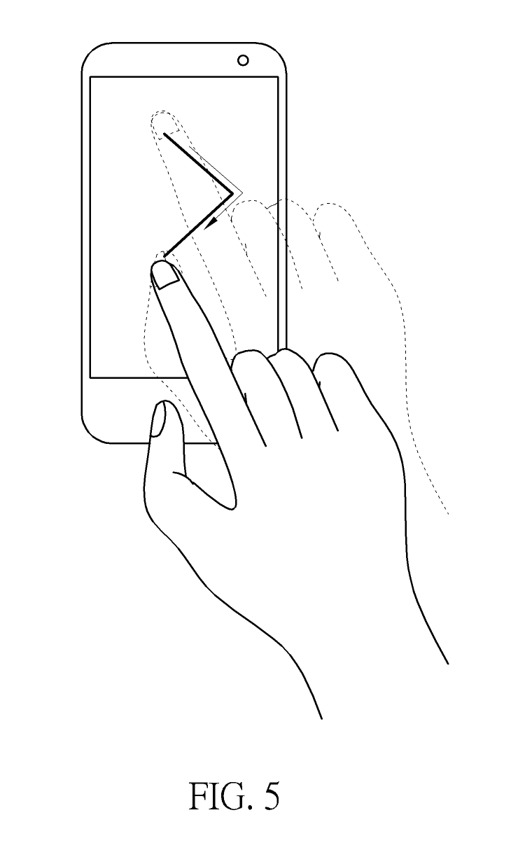

FIG. 5 illustrates a control scheme involved with the method 300 shown in FIG. 3 according to another embodiment of the present invention. For example, the shape of the pre-defined gesture may correspond to the symbol of the virtual button of the UI of the audio player application. In one embodiment, the shape of the pre-defined gesture may correspond to that of the notation “>”, which may comprise (e.g. is formed with) two lines that may be generated by sliding on the touch panel and drawing the notation “>” with one finger of the user, and the pre-defined command may be (or may represent) switching to the next entity to be played by the audio player application, e.g. the Next of Forward command.

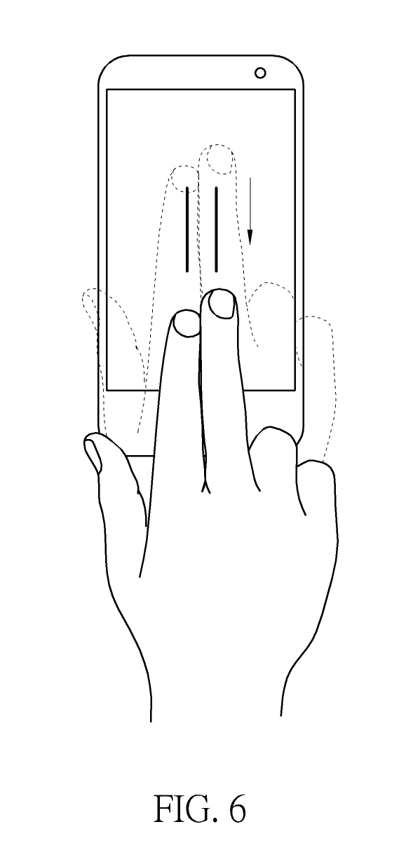

FIG. 6 illustrates a control scheme involved with the method 300 shown in FIG. 3 according to another embodiment of the present invention. For example, the shape of the pre-defined gesture may correspond to the symbol of the virtual button of the UI of the audio player application. In one embodiment, the shape of the pre-defined gesture may correspond to that of the notation “∥”, which may comprise (e.g. is formed with) two vertical lines that may be generated by sliding on the touch panel vertically with two fingers of the user, and the pre-defined command may be (or may represent) pause, e.g. the Pause command.

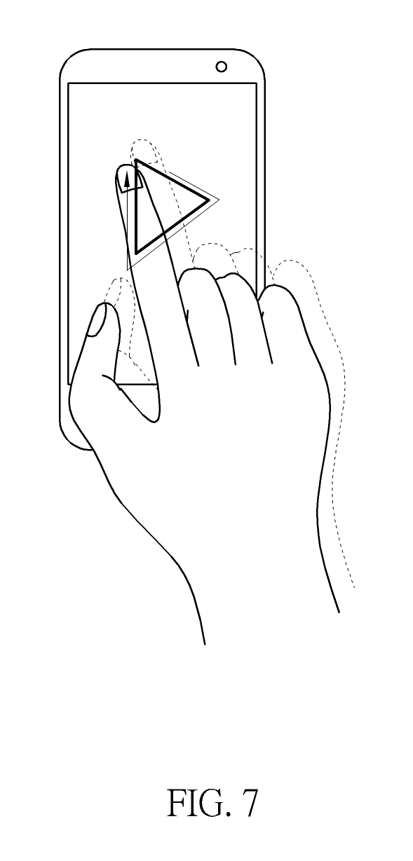

FIG. 7 illustrates a control scheme involved with the method 300 shown in FIG. 3 according to another embodiment of the present invention. For example, the shape of the pre-defined gesture may correspond to the symbol of the virtual button of the UI of the audio player application. In one embodiment, the shape of the pre-defined gesture may correspond to that of a triangle, which may comprise (e.g. is formed with) three lines that may be typically generated by sliding on the touch panel and drawing a triangle with one finger of the user, and the pre-defined command may be (or may represent) play, e.g. the Play command.

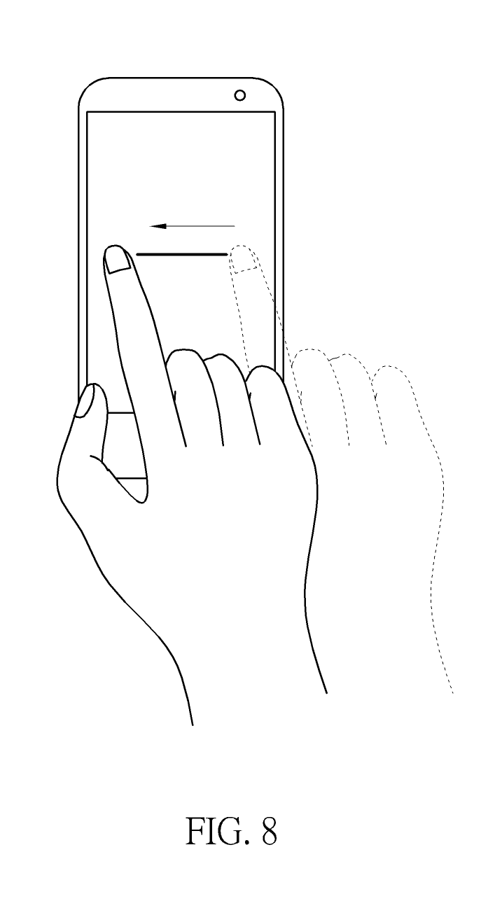

FIG. 8 illustrates a control scheme involved with the method 300 shown in FIG. 3 according to another embodiment of the present invention. For example, the pre-defined gesture may correspond to sliding to the left direction on the touch panel, and the pre-defined command may be (or may represent) switching to the previous entity to be played by the audio player application, e.g. the Previous or Rewind command.

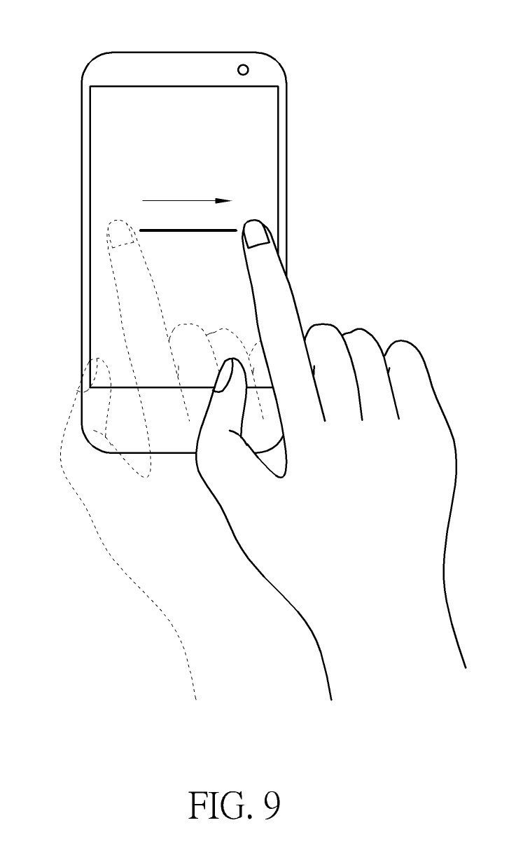

FIG. 9 illustrates a control scheme involved with the method 300 shown in FIG. 3 according to another embodiment of the present invention. For example, the pre-defined gesture may correspond to sliding to the right direction on the touch panel, and the pre-defined command may be (or may represent) switching to the next entity to be played by the audio player application, e.g. the Next or Forward command.

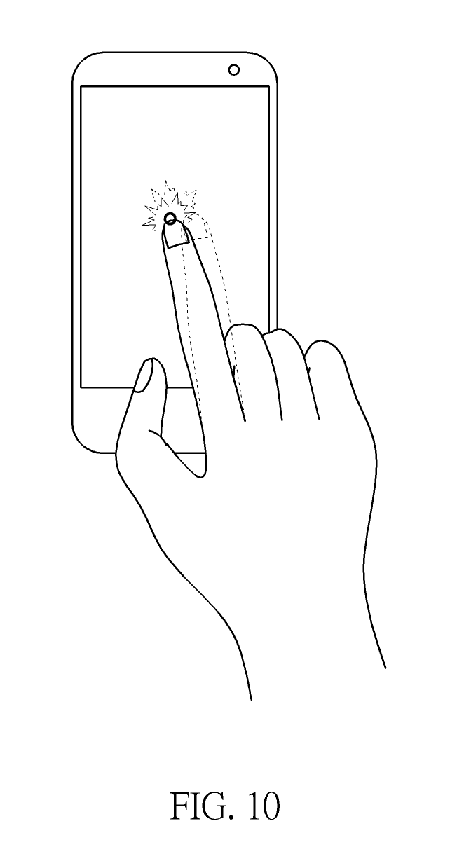

FIG. 10 illustrates a control scheme involved with the method 300 shown in FIG. 3 according to another embodiment of the present invention. In this embodiment, the pre-defined gesture may correspond to double tap, for example, on the touch panel, and the pre-defined command may be (or may represent) at least one of play (e.g. the Play command) and pause (e.g. the Pause command). In one embodiment, when the pre-defined gesture corresponds to double tap, the pre-defined command may toggle between play (e.g. the Play command) and pause (e.g. the Pause command). For example, in a situation where the audio player application is pausing, this pre-defined command may be (or may represent) play (e.g. the Play command). In another example, in a situation where the audio player application is playing an audio file, this pre-defined command may be (or may represent) pause (e.g. the Pause command).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling audio playing of an electronic device, the method comprising the steps of:
controlling a touch panel of the electronic device to be active, to allow at least one touch gesture input to be received from the touch panel while an audio player application is running on the electronic device, wherein when the at least one touch gesture input is received from the touch panel, a screen of the electronic device is kept turned off; and
determining whether a specific touch gesture input of the at least one touch gesture input matches a pre-defined gesture to generate a determining result, and controlling the audio player application to execute a pre-defined command corresponding to the pre-defined gesture based on the determining result.

2. The method of claim 1, further comprising:
during receiving the at least one touch gesture input for the audio player application, preventing the screen of the electronic device from being turned on, to allow the at least one touch gesture input to be received from the touch panel, no matter whether the audio player application is running in foreground or background.

3. The method of claim 1, further comprising:
during receiving the at least one touch gesture input for the audio player application, blocking the at least one touch gesture input from being obtained by any other application, to allow the at least one touch gesture input to be received from the touch panel, no matter whether the audio player application is running in foreground or background.

4. The method of claim 1, further comprising:
during determining whether the specific touch gesture input of the at least one touch gesture input matches the pre-defined gesture to generate the determining result, preventing the screen of the electronic device from being turned on.

5. The method of claim 1, wherein a shape of the pre-defined gesture corresponds to a symbol of a virtual button of a user interface (UI) of the audio player application.

6. The method of claim 1, wherein the pre-defined gesture corresponds to one of sliding to a left direction on the touch panel and sliding to a right direction on the touch panel; and the pre-defined command corresponds to one of switching to a previous entity to be played by the audio player application and switching to a next entity to be played by the audio player application.

7. The method of claim 1, wherein the pre-defined gesture corresponds to double tap; and the pre-defined command corresponds to at least one of play and pause.

8. An apparatus for controlling audio playing of an electronic device, the apparatus comprising at least one portion of the electronic device, the apparatus comprising:
a processing circuit, capable of controlling a touch panel of the electronic device to be active, to allow at least one touch gesture input to be received from the touch panel while an audio player application is running on the electronic device, wherein when the at least one touch gesture input is received from the touch panel, a screen of the electronic device is kept turned off;
wherein the processing circuit is further capable of determining whether a specific touch gesture input of the at least one touch gesture input matches a pre-defined gesture to generate a determining result, and controlling the audio player application to execute a pre-defined command corresponding to the pre-defined gesture based on the determining result.

9. The apparatus of claim 8, wherein during receiving the at least one touch gesture input for the audio player application, the processing circuit prevents the screen of the electronic device from being turned on, to allow the at least one touch gesture input to be received from the touch panel, no matter whether the audio player application is running in foreground or background.

10. The apparatus of claim 8, wherein during receiving the at least one touch gesture input for the audio player application, the processing circuit blocks the at least one touch gesture input from being obtained by any other application, to allow the at least one touch gesture input to be received from the touch panel, no matter whether the audio player application is running in foreground or background.

11. The apparatus of claim 8, wherein during determining whether the specific touch gesture input of the at least one touch gesture input matches the pre-defined gesture to generate the determining result, the processing circuit prevents the screen of the electronic device from being turned on.

12. The apparatus of claim 8, wherein a shape of the pre-defined gesture corresponds to a symbol of a virtual button of a user interface (UI) of the audio player application.

13. The apparatus of claim 8, wherein the pre-defined gesture corresponds to one of sliding to a left direction on the touch panel and sliding to a right direction on the touch panel; and the pre-defined command corresponds to one of switching to a previous entity to be played by the audio player application and switching to a next entity to be played by the audio player application.

14. The apparatus of claim 8, wherein the pre-defined gesture corresponds to double tap; and the pre-defined command corresponds to at least one of play and pause.

15. A computer program product, having program instructions for instructing a processor of an electronic device to perform a method comprising the steps of:
controlling a touch panel of the electronic device to be active, to allow at least one touch gesture input to be received from the touch panel while an audio player application is running on the electronic device, wherein when the at least one touch gesture input is received from the touch panel, a screen of the electronic device is kept turned off; and
determining whether a specific touch gesture input of the at least one touch gesture input matches a pre-defined gesture to generate a determining result, and controlling the audio player application to execute a pre-defined command corresponding to the pre-defined gesture based on the determining result.

16. The computer program product of claim 15, further comprising:
during receiving the at least one touch gesture input for the audio player application, preventing the screen of the electronic device from being turned on, to allow the at least one touch gesture input to be received from the touch panel, no matter whether the audio player application is running in foreground or background.

17. The computer program product of claim 15, further comprising:
during receiving the at least one touch gesture input for the audio player application, blocking the at least one touch gesture input from being obtained by any other application, to allow the at least one touch gesture input to be received from the touch panel, no matter whether the audio player application is running in foreground or background.

18. The computer program product of claim 15, further comprising:
during determining whether the specific touch gesture input of the at least one touch gesture input matches the pre-defined gesture to generate the determining result, preventing the screen of the electronic device from being turned on.

19. The computer program product of claim 15, wherein a shape of the pre-defined gesture corresponds to a symbol of a virtual button of a user interface (UI) of the audio player application.

20. The computer program product of claim 15, wherein the pre-defined gesture corresponds to one of sliding to a left direction on the touch panel and sliding to a right direction on the touch panel; and the pre-defined command corresponds to one of switching to a previous entity to be played by the audio player application and switching to a next entity to be played by the audio player application.
